(19) United States
(12) Patent Application Publication
(10) Pub. No.: US 2016/0380933 A1
(43) Pub. Date: Dec. 29, 2016

(54) SYSTEM AND METHOD FOR PROVIDING CROWD-BASED TECHNICAL SUPPORT TO SMARTPHONE USERS

(71) Applicant: Expert Marketplace, Inc., Ellicott City, MD (US)

(72) Inventors: Dimitrios Topaltzas, Ellicott City, MD (US); Amit Malhotra, Washington, DC (US); Ghazanfar Khan Ghori, Brambleton, VA (US); Fisnik Shpuza, Reston, VA (US); Cary Scott, Annandale, VA (US); Sarib Rahman Mahmood, Herndon, VA (US)

(21) Appl. No.: 15/194,641

(22) Filed: Jun. 28, 2016

Related U.S. Application Data
(60) Provisional application No. 62/185,997, filed on Jun. 29, 2015.

(51) Int. Cl. H04L 12/58; G06F 17/30; H04L 29/06

(52) U.S. Cl. CPC H04L 51/046; H04L 65/1069; H04L 51/38; H04L 65/1063; G06F 17/30684; G06F 17/3053

(57) ABSTRACT

Provided are a system and method of providing chat-based technical support to smartphone users. The system and method include a cloud-based server connected to the internet, and a plurality of smartphone specialists connected to the server. The server is configured to select a group of top ranked specialists based on device tags and keyword tags. The device tags relate to the smartphone. The keyword tags relate to the smartphone user query.

### FIELD OF THE INVENTION

The invention relates to a system and a method of providing chat-based technical support to smartphone users.

### BACKGROUND OF THE INVENTION

Over a billion smartphone devices are sold each year. However, there are often problems with the smartphone. When a user has a question or a problem, it is not easy to provide help in an efficient manner. The user often does not know whether to ask the mobile service provider, the phone's manufacturer, the retail store where they bought phone, or consult online forums. My studies have shown that none of these channels receive high marks from consumers. The reality is that smartphones are very complex devices made up of hardware, software, networking and apps from different companies, and so it's not surprising that no one company has all the answers.

There is a great need to match the problem or question with the right specialist in an efficient and timely manner.

### SUMMARY OF THE INVENTION

An objective of the invention is to provide an efficient and user friendly chat-based smartphone care experience and cater to users that need help with diagnosing a problem, understanding a new handset, learning new capabilities and features, and wanting to optimize performance and battery life. Another objective is to provide turnkey outsourced support services to carriers and original equipment manufacturers (OEMs) around the world. A further objective is to provide better support experience while reducing the cost of each support transaction.

The present system provides a peer-to-peer platform and service for smartphone care. The system matches and connects smartphone users to smartphone specialists. Based on a user's query, the system finds the specialist that is both available and best fit to resolve the query. The user and the specialist can engage one-on-one via the system's live chat interface. The system creates a growing community of independent specialists so that as technology evolves the system base of expertise grows as well. The system creates incentives for specialists based on how well they support users and provides specialists with tools to facilitate diagnosis, research and resolution of the issue.

An example of the present invention is chat-based via the internet. Users enter a free-form query and are greeted by a bot in the form of an owl, which requests or confirms some basic details prior to searching for an appropriate specialist. The system determines a match based on numerous tags in specialists' profiles, which in turn are built up over time from the types of questions that have been successfully answered. Exemplary tags include device tags, such as operating system (OS), model, make, carriers, features and apps (software), and keyword tags based on the user query. Once a specialist is selected, the user and specialist continue the chat. They can exchange messages, images and links. If they have to stop for any reason, they can continue the chat via email. If the query is answered, the user is requested to provide a rating for the experience.

Another example of the system operations includes:
1. A user enters a query via a web or mobile application interface that is connected to an application server.
2. The query's key words are tagged as keyword tags.
3. If missing from the query, the system requests the balance of handset make, model, and carrier, which are device tags.
4. In the specialist matching process, the keyword tags and device tags can be used to search for a group of top available smartphone specialists that are “best fit” and available to respond to the inquiry.
5. The user query is placed into the inquiry queue of each of the best fit specialists and each specialist is alerted to the presence and availability of the query.
6. The first specialist to select “add,” “gets” the user query. The system now opens a chat based communication channel between the user and the specialist.
7. The user and specialist communicate via chat toward solving the inquiry.
8. The user has an opportunity to provide a rating of the specialist's service.
9. The ratings and the tags of the user query can used to enhance the specialties of the specialists for the matching process for a subsequent match.

The objectives and other objectives can be obtained by a method of providing live chat based customer service regarding a user interface comprising:
providing a server connected to the internet, the server comprising non-volatile memory and a processor, the server including a searchable specialist database of a plurality of user interface device specialists each having associated tags regarding user interface devices, and the searchable specialist database being stored in the non-volatile memory;
connecting a user interface device by a user to the server via the internet;
entering a user query by the user into the user interface device;
transmitting the user query to the server via the internet by the user interface device;
tagging key words of the user query by the server as keyword tags;
requesting device tags by the server, the device tags relating to the user interface device;
transmitting the device tags from the user interface device to the server by the user interface device;
providing a plurality of user interface device specialists logged onto the server as available specialists by specialist interface devices connected to the server;
ranking the available specialists based on the keyword tags and device tags by the server;
selecting a group of top ranked available specialists by the server;
queuing the group of top ranked available specialists with the user query by the server; and
a first top ranked available specialist accepting the user interface query and initiating a live chat session with the user.

The objectives and other objectives can also be obtained by a system for providing live chat based customer service regarding a user interface comprising:
a cloud based server connected to a network, the cloud based server being in communication with or comprising at least one non-volatile memory;
a user database stored in the non-volatile memory, constructed for storing user information;
a specialist database stored in the non-volatile memory, constructed for storing information regarding specialists including tags and previous answers, the tags relating to user interface devices and keywords used in user queries regarding user interface devices;
a plurality of specialist interface devices in contact with the server;
at least one user interface device in contact with the server;
a specialist ranking software module constructed for ranking available specialists based on the tags stored in the specialist database when executed on the server to provide a group of ranked available specialists, the specialist ranking software module being stored in the non-volatile memory;
a queuing software module constructed to select a group of top ranked specialists from the group of ranked specialists and to que a user query to the group of top ranked specialists when executed on the server, the queuing software module being stored in the non-volatile memory; and
a live-chat software module constructed to provide a live-chat between a specialist and the user when the specialist accepts the queued query, the live-chat software module being stored in the non-volatile memory.

The objectives can be further obtained by a computer readable medium storing instructions executable by a computing system in non-volatile memory, wherein execution of the instructions implements a method as described herein.

### BRIEF DESCRIPTION OF THE DRAWINGS

FIG. 1 illustrates an overview of the system;

FIG. 2 illustrates a user flow chart;

FIG. 3 illustrates a specialist flow chart;

FIG. 4 is a screenshot of a login page;

FIGS. 5A and 5B are screenshots of the system generated bot;

FIG. 6 is a screenshot of a user screenshot where the user is asked to confirm the accuracy of the device tags;

FIG. 7 is a screenshot of articles from the knowledge database;

FIG. 8 is a screenshot of a when a specialist is not available;

FIG. 9 is a screenshot of a live chat being initiated;

FIG. 10A is a screenshot showing the end of the live chat;

FIG. 10B is a screenshot showing the user being asked to enter a review of the specialist:

FIG. 11 is a screenshot of a user profile;

FIG. 12 is a screenshot of a logon page for a specialist;

FIG. 13 is a screenshot of a specialist dashboard;

FIG. 14 is a screenshot of availability of the specialist;

FIG. 15 is a screenshot of a user query entered into the queue to the group of top ranked specialists;

FIG. 16 is a screenshot of an image or file being attached to the message

FIG. 17 is a screenshot of the user interface device information;

FIG. 18 is a screenshot of keyword tags that can be managed by a specialist; and

FIG. 19 is a screenshot of showing how a specialist can manage user queries.

### DETAILED DESCRIPTION OF THE INVENTION

In the following description, for purposes of explanation and not limitation, specific details are set forth, such as particular networks, communication systems, computers, terminals, devices, components, techniques, storage devices, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, computers, digital devices, storage devices, components, techniques, data and network protocols, software products and systems, development interfaces, operating systems, and hardware are omitted so as not to obscure the description of the present invention.

The invention will now be explained with reference to the attached non-limiting Figs. The operations described in Figs. and herein can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

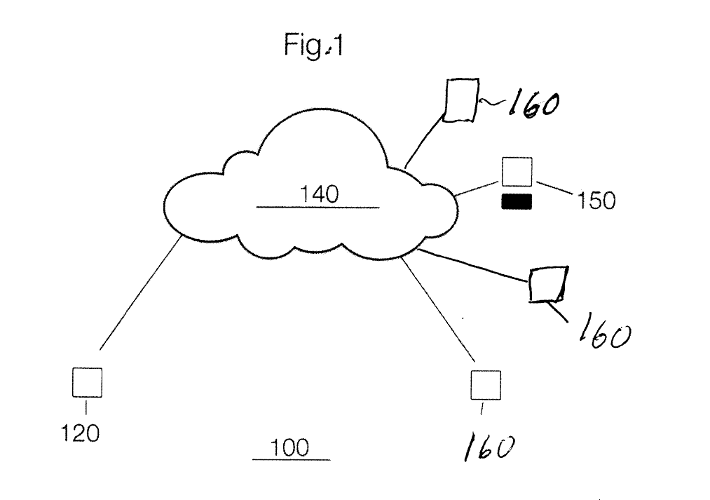

FIG. 1 describes a system 100. The system 100 comprises a user interface device 120, a plurality of specialist interface devices 160, and a main server 150 interconnected via a communication network 140.

Various networks 140 may be implemented in accordance with embodiments of the invention, including a wired or wireless local area network (LAN) and a wide area network (WAN), wireless personal area network (PAN) and other types of networks that comprise or are connected to the Internet. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications, such as by the network 140. Some suitable communications protocols may include TCP/IP, UDP, OSI, Ethernet, WAP, IEEE 802.11, Bluetooth, Zigbee, IrDa or any other desired protocol. Furthermore, components of the system may communicate through a combination of wired or wireless paths, including the telephone networks.

The system 100 can be accessed via any user interface device 120 that is capable of connecting to the main server 150 via the internet. An exemplary user interface device 120 contains a web browser and display. This includes user interface devices 120 such as tablets, iPads, Mac OS computers, Windows computers, e-readers, and mobile user devices such as the iPhone, Android, and Windows Phone, and other communication devices. Preferably, the user interface device 120 is a tablet or smartphone. The smartphone can be in any form, such as a hand held device, wristband, or part of another device, such as vehicle. The user interface devices 120 can connect to the server 150 via the internet and/or wirelessly, such as through a mobile telephone network 140, and/or any other suitable medium. The user interface device 120 preferably includes an I/O interface that allows a user to interact with the system 100. The I/O interface may include any hardware, software, or combination of hardware and software.

The specialist interface device 160 can connect to the server 150 and/or user interface device 120. The specialist interface device 160 can be any device having a web browser and display, such as a laptop computer, desktop computer, tablet, smartphone, or other device, that can connect to the server 150 and/or user interface device 120 through the network 140. The specialist interface device 160 preferably includes an I/O interface that allows a specialist to interact with the system 100. The I/O interface may include any hardware, software, or combination of hardware and software.

The computer processing unit (CPU) of the user interface device 120 and specialist device 160 can be implemented as a conventional microprocessor, application specific integrated circuit (ASIC), digital signal processor (DSP), programmable gate array (PGA), or the like. The CPU executes the instructions that are stored in order to process data. The set of instructions may include various instructions that perform a particular task or tasks, such as those shown in the appended flowchart. Such a set of instructions for performing a particular task may be characterized as a program, software program, software, engine, module, component, mechanism, or tool. The memory may include random access memory (RAM), ready-only memory (ROM), programmable memory, flash memory, and the like. The memory, include application programs, OS, application data etc. The exemplary user interface device 120 and specialist device 160 preferably also includes a network module connected to an antenna to communicate with rest of the system 100.

The main server 150 described herein can include one or more computer systems directly connected to one another and/or connected over the network 140. Each computer system includes a processor, non-volatile memory, user input and user output mechanisms, a network interface, and executable program code (software) comprising computer executable instructions stored in non-transitory tangible memory that executes to control the operation of the main server 150. Similarly, the processors functional components formed of one or more modules of program code executing on one or more computers. Various commercially available computer systems and operating system software can be used to implement the hardware and software. The components of each server can be co-located or distributed. In addition, all or portions of the same software and/or hardware can be used to implement two or more of the functional servers (or processors) shown. The main server 150 can run any desired operating system, such as Windows, Mac OS X, Solaris or any other server based operating systems. Other embodiments can include different functional components. In addition, the present invention is not limited to a particular environment or main server 150 configuration. Preferably, the main server 150 is a cloud based computer system.

The main server 150 includes a web server and the query processing unit. The web server receives the user query and sends it to the query processing unit. The query processing unit processes the user query and responds back to the user interface device 120 via the web server. The query processing unit fetches data from the database server if additional information is needed for processing the user query. The database is stored in the non-volatile memory. The term “database” includes a single database and a plurality of separate databases. The main server 150 can comprise the non-volatile memory or the main server 150 can be in communication with the non-volatile memory storing the database. The database can be stored at different locations.

Software program modules and data stored in the non-volatile memory the main server 150 may be arranged in logical collections of related information on a plurality of computer systems having associated non-volatile memories. The software and data may be stored using any data structures known in the art including files, arrays, linked lists, relational database tables and the like. The server 150 is programed to perform the methods described herein.

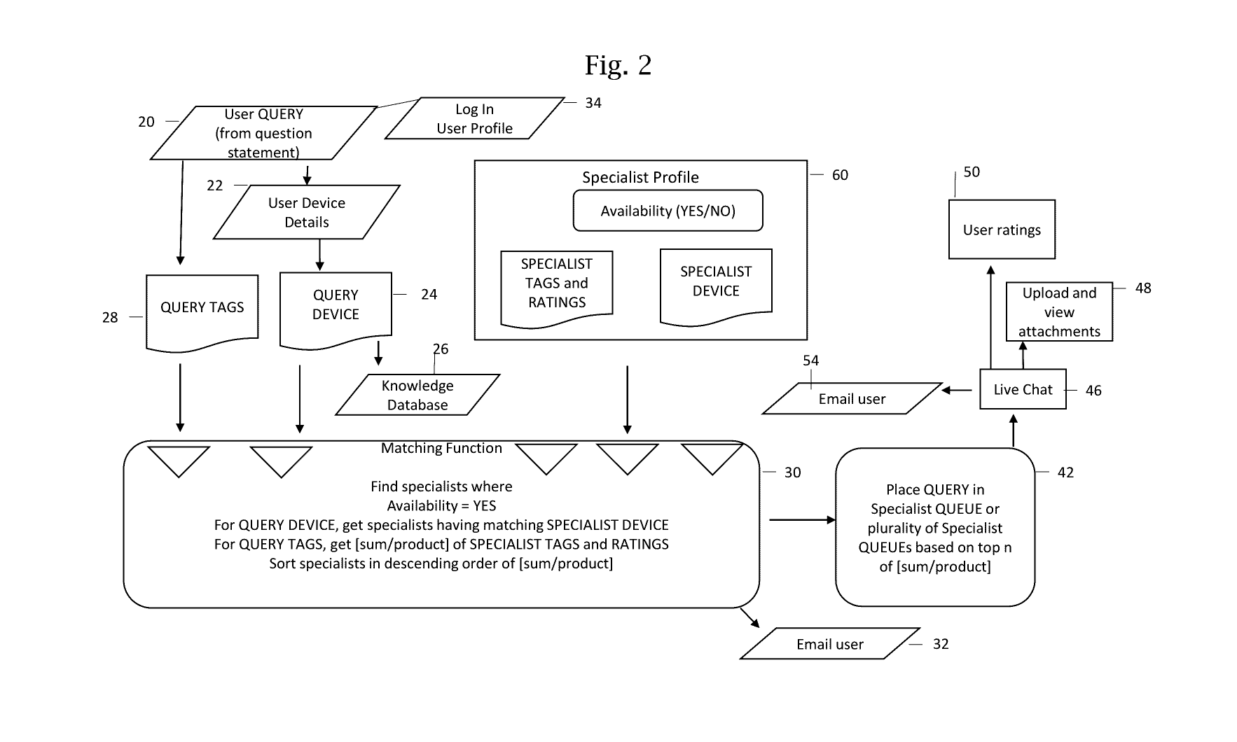

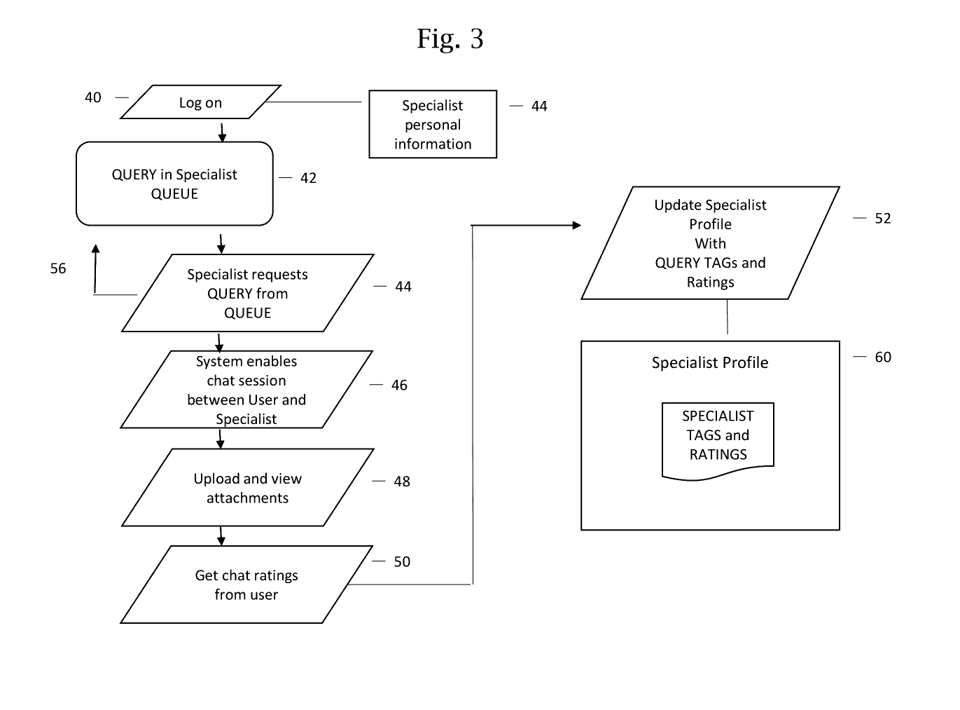

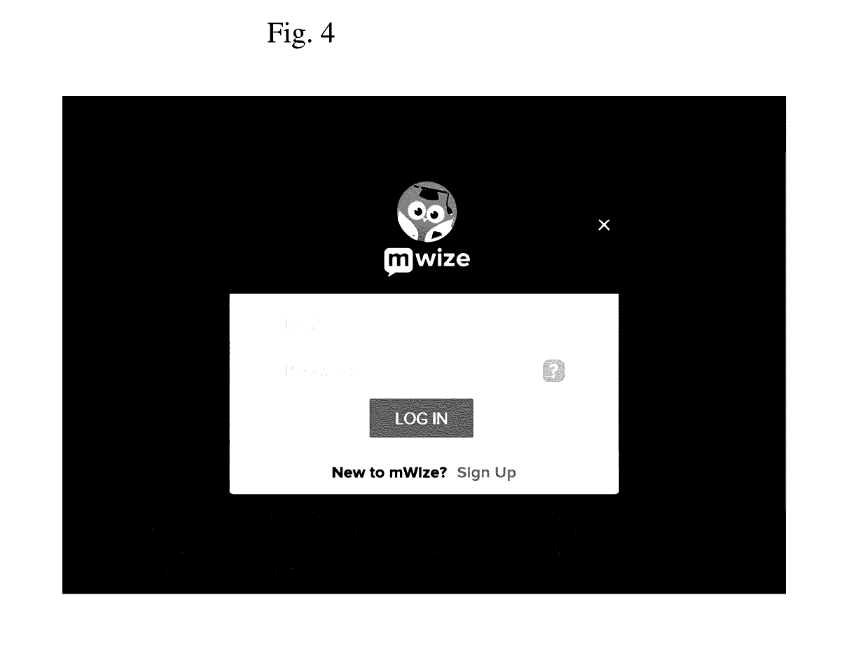

An example of the invention will be explained with reference to the user flow chart of FIG. 2, the specialist flow chart of FIG. 3, and the screenshots shown in FIGS. 4-19. The invention relates to a client/server based system 100 that receives the inquiry and distributes them to crowd-based specialists 160 for research and diagnosis.

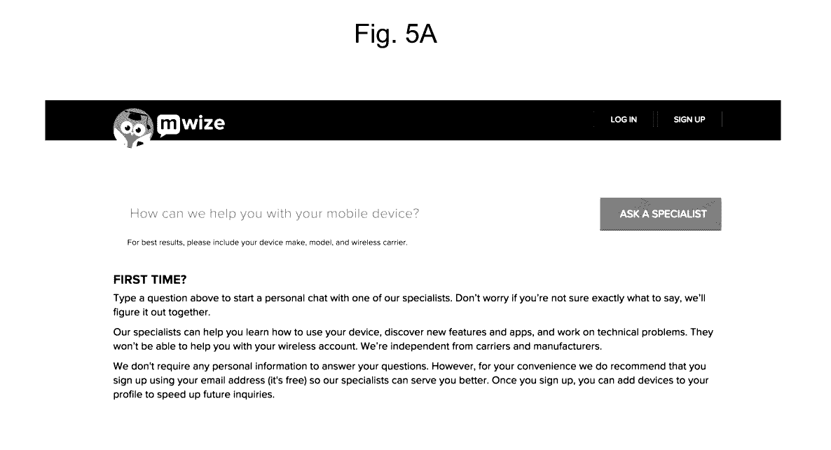

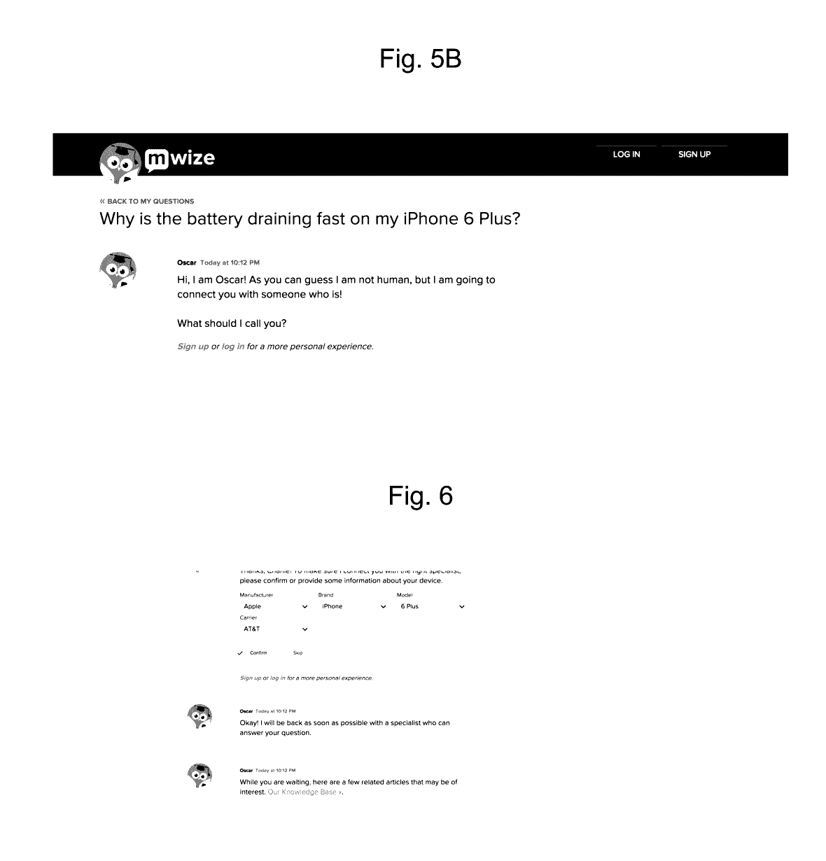

A user connects to the server 150 using the user interface device 120 and sends a query to the server 150, shown at 20. An exemplary user screenshot of the log on page is shown in FIG. 4. The query initiates a chat session with a bot generated by the server 150, shown in the user screenshot of FIG. 5A. The bot can ask the user for additional information, such as name and additional queries, shown in the screenshot of FIG. 5B. The bot can also ask the user to confirm information uploaded to the server 150. Keywords in the query are used by the system 100 as keyword tags, shown at 28.

The user interface device 120 details (device tags), such a smartphone make, model, software installed, language, etc., are uploaded to the server 150, shown at 22. FIG. 6 illustrates a user screenshot where the user is asked to confirm the accuracy of the device tags, shown at 24. The user can enter the device tags or the system can automatically download the device tags from the user interface device 120.

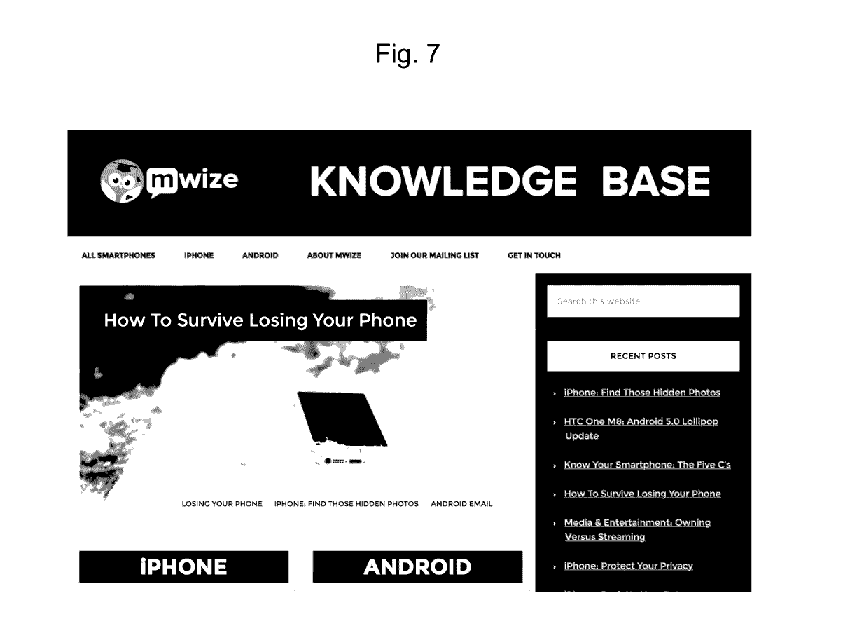

The system can include a knowledge database stored in the non-volatile memory of the server 150. The system 100 can search the knowledge database based on the device tags so that the bot can ask the user to review selected articles regarding the user interface device 120, shown at 26. A user screen shot of articles from the knowledge base is shown in FIG. 7.

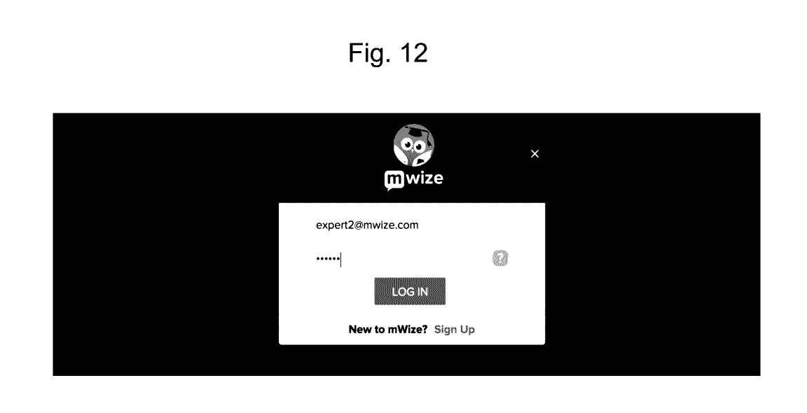

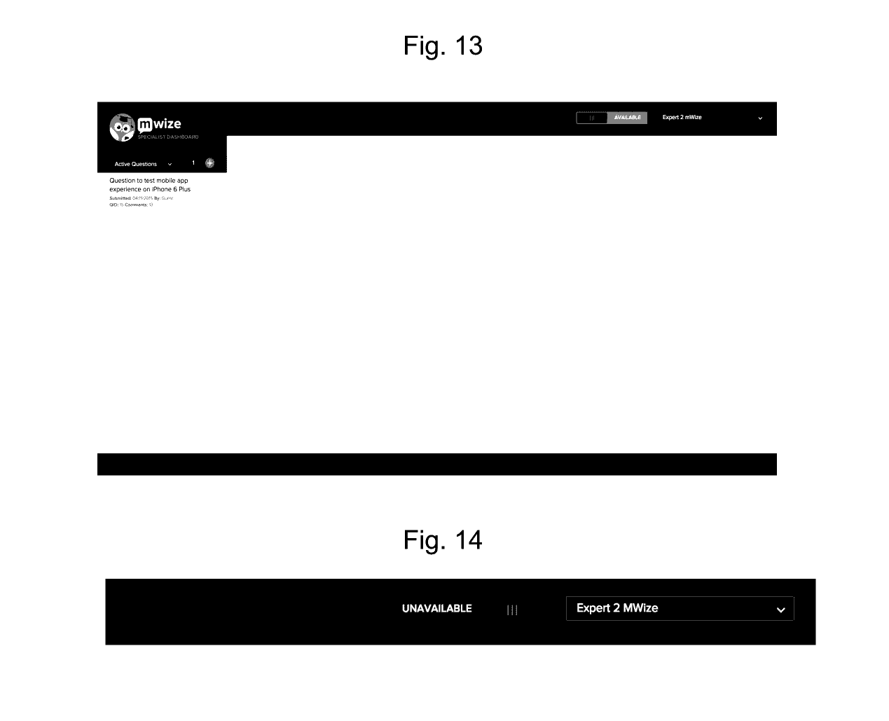

The specialist can log onto the server 150 using the specialist interface device 160, shown at 40. An example of the log on page is shown in the specialist screenshot of FIG. 12. The specialist is then shown a specialist dashboard, as shown in specialist screenshot of FIG. 13, shown at 42. The specialist dashboard can display a “my questions section” showing user queries, a “live chat window, user, and user interface device information” that can provide detail related to a query accepted by the specialist, a “messages” section that displays any messages, and an “available, unavailable” provide section.

The specialist can select available or unavailable, as shown in the specialist screenshot of FIG. 14, shown at 42. While the specialist is working with a user during a live chat, the specialist can select “unavailable” to prevent interruptions.

When a specialist logs onto the server 150 for the first time, the specialist can enter personal data into the system 100, shown at 42. Exemplary personal data includes, name, address, languages spoken, type of user interface devices they are familiar with, software they are familiar with, and other work experience. The personal data can be stored in the specialist database in the non-volatile memory of the server 150, shown at 60.

The specialist database can further store past user queries, specialist answers, and user reviews of the specialist, shown at 60. Thus, the specialist database can include the following information regarding the specialists:
Name.
Type smartphone the specialist is familiar with, based on device tags.
Type of software the specialist is familiar with, based on keyword tags.
Type of software the specialist is familiar with, based on keyword tags.
Parts of smartphone the specialist is familiar with, based on device tags.
Previous answers by specialist.
Review of specialist by past users.

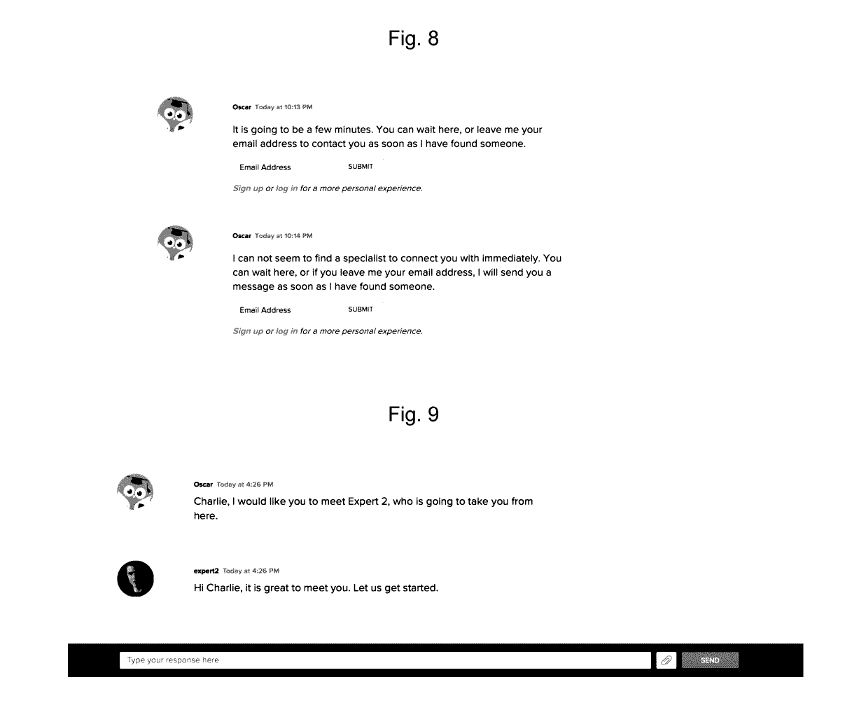

The system 100 searches for a group of top ranked available specialists from the specialist database based on the tags, and user reviews, shown at 30. If no specialist is available, the bot informs the user of a lack of a specialist and requests an email, telephone number to text messaging, or other means of contact so that the system 100 can contact the user via email or text when a specialist is available, or the user can wait until a specialist is available, shown at 32. FIG. 8 shows a user screenshot when a specialist is not available. No specialist available means that a minimum competency for the available specialists has not been met, such as, none of the available specialists are familiar with the specific user interface device 120.

An Exemplary matching algorithm executed by the server 150 includes:
1. Compare user tags (device and keyword tags) to the tags stored in the specialist database.
2. For all available specialists, determine a specialty score based on number of user tags matching the specialist tags stored in the specialist database. The specialty score can also be based on user ratings.
3. Sort the available specialists in decreasing order of specialty score.
4. Selecting a group of top ranked available specialist having the highest specialty scores.

The group of top ranked available specialists can be for example the top 30% or less, more preferably the top 20% or less, and most preferably the top 10% or less of the available specialists. The term “or less” is intended to include the number (i.e. 30) and any percentage down to the percentage represented by the top two specialists. In general, the greater the number of available specialists, the higher the rank of the group of top ranked specialists, i.e. 10% or less for a larger group of available specialists vs. 20% or less for a smaller group of available specialists. In general, the larger the number of specialists the more efficient and better the system becomes. With a larger number of specialists, there is a greater chance that a specialist will know the answer to the query without having to research the solution or ask for additional help.

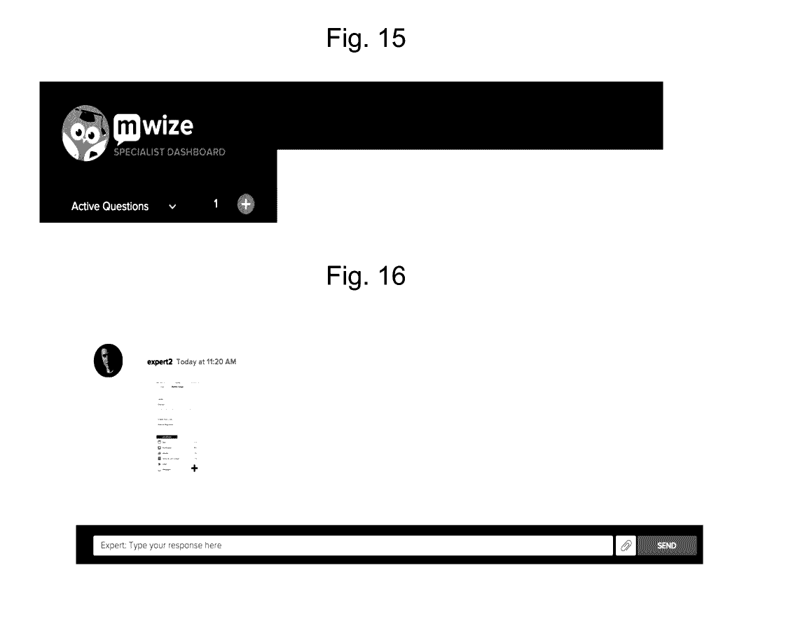

After the group of top ranked available specialists are selected from the available specialists, the user query is entered into the queue to the group of top ranked specialists, shown in the specialist screenshot of FIG. 15, and shown at 42. The system can alert the top ranked specialists, for example by displaying a “+” sign at the top of the Questions section. The specialist can be a top ranked specialist for more than one user query, in which case a list of queries can be displayed as Active Questions.

The first specialist to accept the query, shown at 44, is then selected to initiate a live chat session with the user, shown at 46, on the user screenshot in FIG. 9. During the live chat session, the user can upload attachments, shown at 48 and in FIG. 16, such as user interface device 120 screenshots, by clicking on a paperclip at the bottom of the display screen. Selecting the paperclip allows the user to upload a file for the specialist to review. In addition to the user screenshots, other file types can be uploaded. The size of the file can be limited by the system, such as 5 MB in size or less, and can be in any desired format, preferably, but not limited to .doc, .docx, .jpg or .pdf formats. When the user clicks the paperclip, the user can be asked to select a file from the user interface device 120 to upload. Once the user navigates to the file and clicks on the file, a thumbnail image of the file will appear above the paper clip, with a small red ‘x’ in the lower right corner. The user can click on the ‘x’ to remove the file. The user can then click the paper clip again to add more files, or click ‘Send’ to forward the files to the specialist. Once the file transfer is complete, the system can generate thumbnails of the files can appear in message bubbles similar to other messages. Each thumbnail can have a ‘+’ in the lower right corner which, when clicked, can expand the file for the user or specialist to review.

The specialist can select and review past queries and answers during the live chat. If a past query is selected, the system can display related information with the past query, such as the chat for the past query, tags associated with the past query, stock messages that can be sent to the user, and/or related questions and answers resolved by other specialists which match the tags the query.

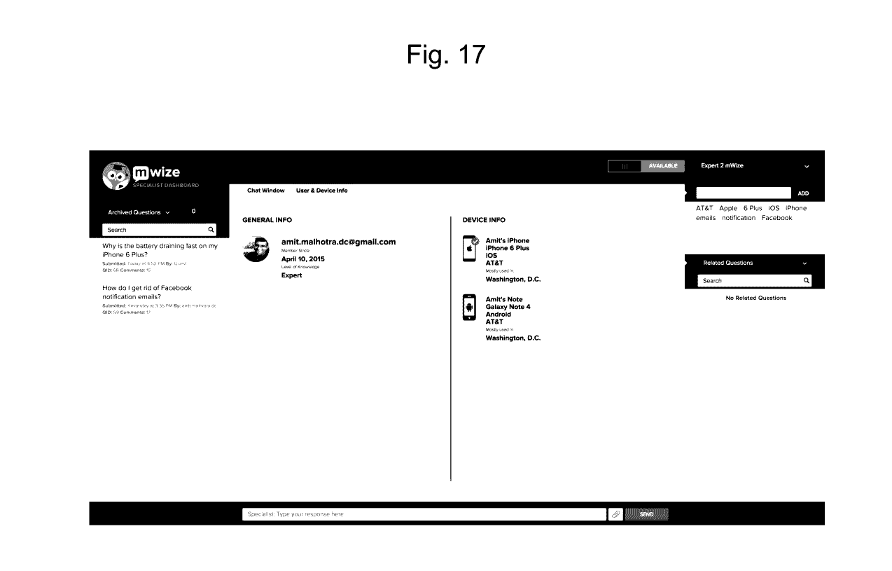

The specialist can request the system 100 to display the user interface device information including the device tags, such as shown in the specialist screenshot of FIG. 17.

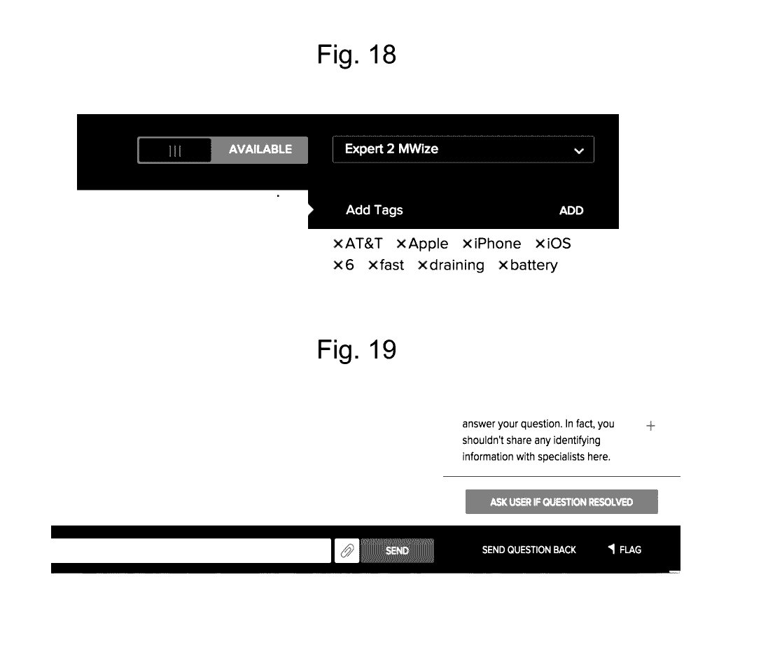

Tags are an important aspect system 100. The specialists can manage keyword tags associated with a user query. In the Specialist Dashboard, tags appear in the top left, as shown in the specialist screenshot of FIG. 18. The system 100 can initially derive keyword tags from the user query and additional information provided, if any, about the device and carrier (device tags). The specialist can have the capability to delete irrelevant tags, for example by clicking on a red ‘x’ next to any tag, or adding a tag by typing the new tag into the box and clicking ‘Add,’ as shown in the specialist screenshot of FIG. 18. If desired, the system 100 can be configured so that the specialist cannot undo the deletion of a tag. If extraneous words, such as “and”, are picked up as tags, the specialist can delete these extraneous words so they do not dilute the meaningful tags.

Tags have several impacts on the system 100. A specialist's profile can evolve with experience to include specialties based on successfully resolved questions; specialties are combinations tags; so for example if the specialist were to resolve a question regarding Facebook for the first time, a Facebook tag would be added as a specialty in that specialist's profile in the specialist database, shown at 52. When a user asks a query, the initial set of tags are used to identify specialists with matching specialties for assignment. As new topics develop in the marketplace, such as a new type of technology or a new app, new tags will ensure that the system 100 correspondingly evolves the collective expertise.

If the user has provided the system 100 with an email address, the specialist managing the query can have the ability to send that user a message that will arrive via email, shown at 54. This is useful if the user is not be present on the system 100, or if the specialist wants to provide some information without the user returning to the system 100. An example of such an email might be a suggestion for a particular time that the user and specialist should continue the live chat. If a user leaves the live chat session before the conversation is complete, the conversation can be completed by email if the user has entered the users' email into the system 100, shown at 54. If the user's email is available, the specialist can see a button in the top right corner of the chat window, “Send Email.” Clicking on the button will present a popup window in which you can enter your message and click “Send.” The message will be sent to the user as an email.

In the right hand column of the Specialist Dashboard tools to help the specialist manage queries can be provided. One of these is a set of Messages, or stock text that the specialist can send users. Messages are categorized as General, iOS and Android. These lists can be selected via a dropdown menu, but are only available when the specialist viewing an Active Question. If the specialist clicks the ‘+’ in any stock message, the text will appear in the response box of the chat stream. The specialist can edit it as needed before sending.

Another useful resource in this area is Related Questions. Related Questions can be user queries matching the tags of the query the specialist is presently viewing, that have been previously resolved by another specialist. The system 100 provides the specialist managing a query targeted access to similar queries, which may save the specialist time in researching the topic and arriving at an answer. Related Questions can be selected by the specialist via the same dropdown menu as Messages in the previous section, and appear in place of the Messages lists.

If it looks like the user has the answer the user needs, the specialist can proceed to close out the conversation and encourage the user to provide a specialist rating, shown at 50 and the specialist screenshot of FIG. 19. This can be done by clicking on the green button at the bottom of the Messages/Related Question section. Clicking the button will send the user a series of messages and, assuming the answer is “Yes,” a rating and feedback form, as shown in “Consumer View: Resolution and Rating” earlier. If the answer is “No,” the specialist will be notified and can continue the chat. Note: if the answer is “No,” the system 100 can automatically send the user a stock message from the specialist, “Oops, let me try again” so that the specialist can follow up with another message.

The specialist preferably does not see the rating or feedback provided by the user. The specialist only see the generic message “RESOLVED . . . . ” sent by Oscar, and the question will immediately move into the specialist list of Archived Questions. The specialist can view the impact of the resolution and rating on the total number of points in the specialist profile.

Occasionally the specialist may need to relinquish an active user query because the specialist does not feel capable of managing query, shown at 56. The specialist can click “Send Question Back” in the lower left corner of the Specialist Dashboard. Note that this button only appears when the specialist has selected a user query from the specialist's Active Questions list. This action will send the query back to the queue and bring up a popup window in which the specialist enter notes for the next specialist and click “Submit.”

If the specialist believes there is an issue with the user query that will make it difficult for any specialist to manage (for example, it appears to be a prank or a malicious question), the specialist can escalate the suspicious user qeury to system administrators by clicking on “Flag Question” in the lower left corner of the Specialist Dashboard. Note that this button only appears when the specialist has selected a query from your Active Questions list. This action will bring up a popup window in which the specialist can state why they are flagging the query. When the specialist clicks “Submit,” the query is removed from the queue entirely, although the remove query can be reassigned to other specialists after review by administrators. All comments provided by specialists when sending back or flagging a question can appear as internal notes in the chat stream, preferably not visible to the user.

The specialist can manage aspects of the specialist profile in the upper right corner of the dashboard. Clicking on the box with the chat name, and the specialist profile section will open up. Here the specialist will be able to:
See the specialist current profile photo and the number of points earned;
Change the specialist password;
Change the profile photo;
Download a report of the specialist activity; or
Log out.

Specialists can accrue points as rewards for managing and successfully resolving queries. Points are a function of activity on a query and the rating provided by the user, although there may not be a 1:1 relationship between the number of stars in the user's rating and the number of points earned. The total number of points earned to date appears under the specialist picture when the specialist visits the specialist profile, as well as in the specialist activity report that the specialist can download from within the specialist profile. At this time the system 100 can still be determining the payout associated with these points.

Each specialist can manage a maximum of three questions at a time. So as not to keep consumers waiting, even if the specialist is presently working a question, the specialist can be encouraged by the system 100 to accept another user query if the specialist sees the red+flashing. The specialist can introduce themself and perhaps ask for more information to assist the specialist in arriving at an answer, and then multi-task between the multiple user queries.

The bot tries to capture the device tags and the specialist should be able to see those if the specialist scrolls up in the chat stream. One thing the system bot may avoid asking can be the specific operating system (OS) version because the OS may be too complicated. Thus, the specialist can ask the user what OS they are using, as well as any other basic information that might affect how the specialist will answer the question. Alternatively, the OS and other device tags can be automatically downloaded by the system 100 from the user interface device 120.

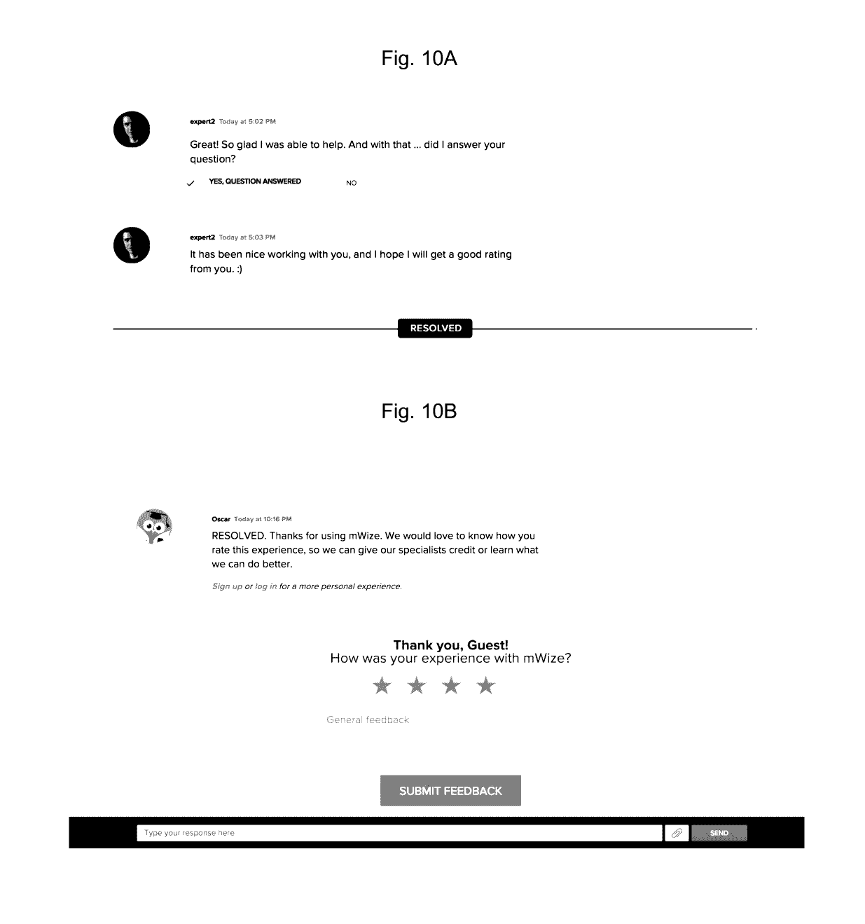

At the end of the live chat session, the user is presented with a question as whether the user query was answered, as shown in the user screenshot shown in FIG. 10A. The user can also enter feedback regarding the specialist, shown at 50 and in the user screenshot of FIG. 10B. The user query, specialist answer and feedback are stored in the specialist data base on the server 150.

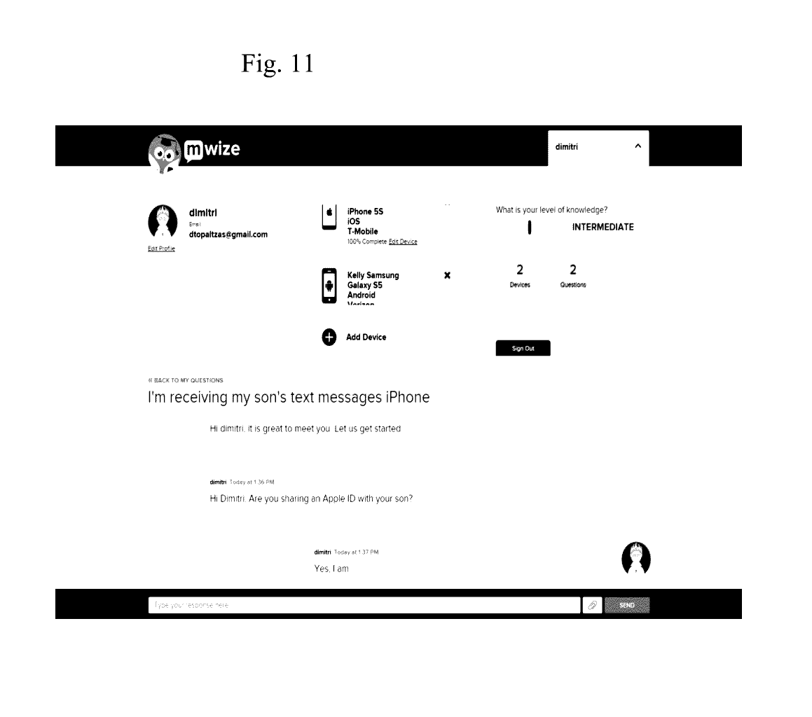

The user is encouraged to setup a user profile within the system 100, which is stored in a user profile database stored in the non-volatile memory of the server 150, as shown in the screenshot of FIG. 11 and at 34. The user profile can store past user queries, personal information regarding the user, contact information of the user, such as email, and user interface device 120 information.

Alternatively, the user can connect to the system 100 from a home computer or other user interface device 120 than the user interface device being queried. In this instance, the user will have to enter the device tags for the desired user interface device 120 into the server 150.

The invention further relates to a system for providing live chat based customer service regarding a user interface device comprising:
a cloud based server 150 connected to a network 140, the cloud based server 150 being in communication with or comprising at least one non-volatile memory;
a user database stored in the non-volatile memory, constructed for storing user information;
a specialist database stored in the non-volatile memory, constructed for storing information regarding specialists including tags and previous answers, the tags relating to user interface devices and keywords used in user queries regarding user interface devices;
a plurality of specialist interface devices 160 in contact with the server;
at least one user interface device 120 in contact with the server;
a specialist ranking software module constructed for ranking available specialists based on the tags stored in the specialist database when executed on the server to provide a group of ranked available specialists, the specialist ranking software module being stored in the non-volatile memory;
a queuing software module constructed to select a group of top ranked specialists from the group of ranked specialists and to que a user query to the group of top ranked specialists when executed on the server, the queuing software module being stored in the non-volatile memory; and
a live-chat software module constructed to provide a live-chat between a specialist and the user when the specialist accepts the queued query, the live-chat software module being stored in the non-volatile memory.

The system can further comprises a knowledge database stored in the non-volatile memory, the knowledge interface containing articles relating to user interface devices. The system can also include a bot software module constructed to provide a system generated bot when executed by the server, the bot software module being stored in the non-volatile memory. The system can also contain an email software module constructed to allow a specialist to email the user, the email software module being stored in the non-volatile memory. The system can further comprise a specialist review software module constructed to allow the user to enter a review of the specialist into the specialist database at the end of the live chat, the specialist review software module being store in the non-volatile memory.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1. A method of providing live chat based customer service regarding a user interface comprising:
providing a server connected to the internet, the server comprising non-volatile memory and a processor, the server including a searchable specialist database of a plurality of user interface device specialists each having associated tags regarding user interface devices, and the searchable specialist database being stored in the non-volatile memory;
connecting a user interface device by a user to the server via the internet;
entering a user query by the user into the user interface device;
transmitting the user query to the server via the internet by the user interface device;
tagging key words of the user query by the server as keyword tags;
requesting device tags by the server, the device tags relating to the user interface device;
transmitting the device tags from the user interface device to the server by the user interface device;
providing a plurality of user interface device specialists logged onto the server as available specialists by specialist interface devices connected to the server;
ranking the available specialists based on the keyword tags and device tags by the server;
selecting a group of top ranked available specialists by the server;
queuing the group of top ranked available specialists with the user query by the server; and
a first top ranked available specialist accepting the user interface query and initiating a live chat session with the user.

2. The method according to claim 1, wherein the user interface device is a smartphone.

3. The method according to claim 1, wherein the specialist database further includes previous answers by specialists.

4. The method according to claim 1, further comprising the user entering a review the specialist into the system when the live chat is completed, wherein the review is stored in the specialist database and used in the ranking step.

5. The method according to claim 1, further comprising the user entering information into a user database stored in the non-volatile memory of the server.

6. The method according to claim 1, further comprising providing a knowledge database stored in the non-volatile memory of the server containing articles relating to the user interface device, and presenting to the user at least one article from the knowledge database.

7. The method according to claim 1, wherein the top ranked available specialists are the top 30% or less of the ranked available specialists.

8. The method according to claim 1, wherein the top ranked available specialists are the top 20% or less of the ranked available specialists.

9. The method according to claim 1, wherein the top ranked available specialists are the top 10% or less of the ranked available specialists.

10. The method according to claim 1, further comprising the user entering an email address into the system, and the specialist contacting the user via the email.

11. The method according to claim 1, further comprising generating a bot by the system and having the bot greet the user when the user logs onto the system.

12. The method according to claim 11, wherein the bot requests further information from the user regarding the user interface device.

13. The method according to claim 1, further comprising the specialist editing the keyword tags stored in the non-volatile memory.

14. A computer readable medium storing instructions executable by a computing system in non-volatile memory, wherein execution of the instructions implements a method according to claim 1.

15. A system for providing live chat based customer service regarding a user interface comprising:
a cloud based server connected to a network, the cloud based server being in communication with or comprising at least one non-volatile memory;
a user database stored in the non-volatile memory, constructed for storing user information;
a specialist database stored in the non-volatile memory, constructed for storing information regarding specialists including tags and previous answers, the tags relating to user interface devices and keywords used in user queries regarding user interface devices;
a plurality of specialist interface devices in contact with the server;
at least one user interface device in contact with the server;
a specialist ranking software module constructed for ranking available specialists based on the tags stored in the specialist database when executed on the server to provide a group of ranked available specialists, the specialist ranking software module being stored in the non-volatile memory;
a queuing software module constructed to select a group of top ranked specialists from the group of ranked specialists and to que a user query to the group of top ranked specialists when executed on the server, the queuing software module being stored in the non-volatile memory; and
a live-chat software module constructed to provide a live-chat between a specialist and the user when the specialist accepts the queued query, the live-chat software module being stored in the non-volatile memory.

16. The system according to claim 15, further comprising a knowledge database stored in the non-volatile memory, the knowledge interface containing articles relating to user interface devices.

17. The system according to claim 15, further comprising a bot software module constructed to provide a system generated bot when executed by the server, the bot software module being stored in the non-volatile memory.

18. The system according to claim 15, further comprising an email software module constructed to allow a specialist to email the user, the email software module being stored in the non-volatile memory.

19. The system according to claim 15, further comprising a specialist review software module constructed to allow the user to enter a review of the specialist into the specialist database at the end of the live chat, the specialist review software module being store in the non-volatile memory.
